(19) United States
(12) Patent Application Publication
(10) Pub. No.: US 2021/0302853 A1
(43) Pub. Date: Sep. 30, 2021

(54) TONER

(71) Applicant: CANON KABUSHIKI KAISHA, Tokyo (JP)

(72) Inventors: Kazuki Murata, Ibaraki (JP); Koh Ishigami, Chiba (JP); Shin Kitamura, Ibaraki (JP); Nobuyoshi Sugahara, Tokyo (JP); Takaho Shibata, Tokyo (JP); Toru Takahashi, Ibaraki (JP); Kazunari Ooyama, Ibaraki (JP); Yuu Nishimura, Chiba (JP); Daisuke Tsujimoto, Tokyo (JP); Ryo Nakajima, Chiba (JP); Hitoshi Sano, Chiba (JP)

(21) Appl. No.: 17/210,961

(22) Filed: Mar. 24, 2021

(30) Foreign Application Priority Data
Mar. 31, 2020 (JP) 2020-063233
Mar. 1, 2021 (JP) 2021-031660

(51) Int. Cl. G03G 9/087

(52) U.S. Cl. CPC G03G 9/08755; G03G 9/08731; G03G 9/08728

(57) ABSTRACT

A toner comprising a toner particle containing a binder resin and a polymer A, wherein the binder resin contains a polyester resin having a specific structure, the polymer A has a first monomer unit derived from a specific (meth)acrylic acid ester and a second monomer unit different from the first monomer unit, a content ratio of the first monomer unit in the polymer A is 5.0 mol % to 60.0 mol % while a content ratio of the second monomer unit in the polymer A is 20.0 mol % to 95.0 mol %, and the SP value of the first monomer unit, the SP value of the second monomer unit, and the SP value of a silicone segment contained in the specific structure satisfy a specific relationship.

### BACKGROUND OF THE INVENTION

### Field of the Invention

The present disclosure relates to a toner for use in electrophotographic systems, electrostatic recording systems, electrostatic printing systems, toner jet systems, and the like.

### Description of the Related Art

In recent years, toners with greater color stability of printed images have been in demand for image formation. Specifically, there is demand for toners that are resistant to changes in charge quantity so that the developing efficiency is stable even during long-term image output.

For example, Japanese Patent Application Publication No. 2002-12657 uses a composite polyester resin including a silicone oil bound to a polyester resin in an effort to improve charge stability.

### SUMMARY OF THE INVENTION

However, it turns out that further improvements are necessary because even with a toner such as that described in Japanese Patent Application Publication No. 2002-12657, the charge quantity may decline when a copier is moved from an environment in which, for example, the air conditioning is turned off for a certain period due to a long summer vacation. Furthermore, as full-color printers have become commercially available, the scratch resistance of a printed image is gaining attention. When an image, printed with a toner having low adhesiveness with the paper, is scratched with a fingernail or the like, the toner may detach from the paper.

When a composite polyester such as that described above is used as a main binder of a toner, adhesiveness between a toner and paper is reduced because the polarity is low. Image scratches occur as a result, and further improvement is needed. The present disclosure provides a toner with further improved charge stability and excellent image scratch resistance.

A toner comprising a toner particle containing a binder resin and a polymer A, wherein the binder resin contains a polyester resin having a structure represented by formula (B) below:

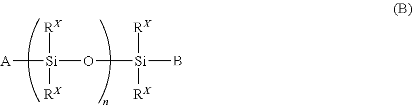

in formula (B) each R^{x} independently represents a hydrogen atom, methyl group or phenyl group,
A represents a polyester segment,
B represents a polyester segment or any functional group selected from the group consisting of —R²⁰OH, —R²⁰COOH,

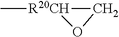

and —R²⁰NH₂, where
R²⁰ represents a single bond or C₁₋₄ alkylene group, and an average number of repetitions n is 10 to 80,

the polymer A comprises a first monomer unit having a structure represented by formula (I) below and a second monomer unit that is different from the first monomer unit:

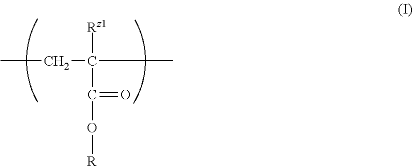

in formula (I), R^{Z1} represents a hydrogen atom or methyl group, and R represents a C₁₈₋₁₆ alkyl group,

a content ratio of the first monomer unit in the polymer A is 5.0 mol % to 60.0 mol % based on a total molar amount of all monomer units in the polymer A,

a content ratio of the second monomer unit in the polymer A is 20.0 mol % to 95.0 mol % based on a total molar amount of all monomer units in the polymer A, and

when SP1 (J/cm³)^{0.5} is an SP value of the first monomer unit, and SP2 (J/cm³)^{0.5} is an SP value of the second monomer unit, and SP3 (J/cm³)^{0.5} is an SP value of a silicone segment represented by —(Si(R^{x})₂O)ₙ—Si(R^{x})₂— in the structure represented by formula (B), formulae (1) to (3) below are satisfied:

SP1≤18.4 (1)

21.0≤SP2 (2)

SP1−SP3<SP2−SP1 (3)

The present disclosure provides a toner with further improved charge stability and excellent image scratch resistance. Further features of the present invention will become apparent from the following description of exemplary embodiments.

### DESCRIPTION OF THE EMBODIMENTS

The descriptions of “from XX to YY” or “XX to YY” representing a numerical range mean a numerical range including the lower limit and the upper limit which are endpoints, unless otherwise noted. A (meth)acrylic acid ester means an acrylic acid ester and/or a methacrylic acid ester. A “monomer unit” means a reacted form of a monomer substance in a polymer, and one carbon-carbon bonded section in a principal chain composed of polymerized vinyl monomers in a polymer is considered as one unit. A vinyl monomer can be represented by the following formula (Z):

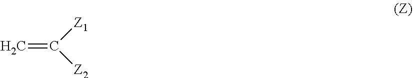

[in formula (Z), Z₁ represents a hydrogen atom or an alkyl group (preferably a C₁₋₃ alkyl group, or more preferably a methyl group), and Z₂ represents an optional substituent].

A crystalline resin is a resin that exhibits a clear endothermic peak in differential scanning calorimetry (DSC).

The present disclosure relates to a toner comprising a toner particle containing a binder resin and a polymer A, wherein

the binder resin contains a polyester resin having a structure represented by formula (B) below:

in formula (B) each R^{x} independently represents a hydrogen atom, methyl group or phenyl group,
A represents a polyester segment,
B represents a polyester segment or any functional group selected from the group consisting of —R²⁰OH, —R²⁰COOH,

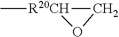

and —R²⁰NH₂, where
R²⁰ represents a single bond or C₁₋₄ alkylene group, and
an average number of repetitions n is 10 to 80,

the polymer A comprises a first monomer unit having a structure represented by formula (I) below and a second monomer unit that is different from the first monomer unit:

in formula (I), R^{Z1} represents a hydrogen atom or methyl group, and R represents a C₁₈₋₃₆ alkyl group,

a content ratio of the first monomer unit in the polymer A is 5.0 mol % to 60.0 mol % based on a total molar amount of all monomer units in the polymer A,

a content ratio of the second monomer unit in the polymer A is 20.0 mol % to 95.0 mol % based on a total molar amount of all monomer units in the polymer A, and

when SP1 (J/cm³)^{0.5} is an SP value of the first monomer unit, and SP2(J/cm³)^{0.5} is an SP value of the second monomer unit, and moreover SP3 (J/cm³)^{0.5} is an SP value of a silicone segment represented by —(Si(R^{x})₂O)ₙ—Si(R^{x})₂— in the structure represented by formula (B), formulae (1) to (3) below are satisfied:

SP1≤18.4 (1)

21.0≤SP2 (2)

SP1−SP3<SP2−SP1 (3).

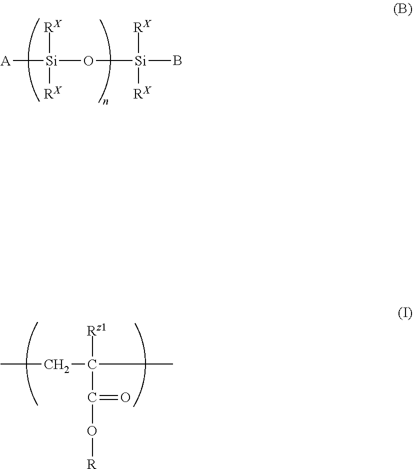

The segment represented by —(Si(R^{x})₂O)ₙ—Si(R^{x})₂— in the structure represented by formula (B), or in other words the structure of formula (B) minus the A and B parts, is also called a silicone segment.

The inventors discovered as a result of earnest research that the above problems could be solved by controlling the molar ratio and SP value of the monomer unit represented by formula (I) and the relationships among SP values within predetermined ranges in the polymer A that is added to a polyester resin having the structure represented by formula (B). The inventors hypothesize that these problems were solved for the following reasons.

A polyester resin having the structure represented by formula (B) is a resin including a high-polarity polyester segment bound (by covalent binding for example) to a silicone segment having low polarity. The silicone segment has good charge stability due to its low polarity, but because there is charge leakage from the high-polarity polyester segment, further improvements in charge stability were needed for long-term storage. Image scratching has also been a problem because the silicone segment has poor adhesiveness on paper.

The inventors therefore investigated a toner including a crystalline resin having a monomer unit with a high SP value bound thereto, added to a polyester resin having the structure represented by formula (B). As a result, it was found that not only was charge stability further improved, but image scratch resistance was also good. If the first monomer unit of the polymer A satisfies the formula (1) above (SP1≤18.4), the silicone segment of a polyester resin having the structure represented by formula (B) has greater affinity for the first monomer unit of the polymer A. If the second monomer unit of the polymer A satisfies the formula (2) above (21.0≤SP2), the polyester segment of a polyester resin having the structure represented by formula (B) has greater affinity for the second monomer unit of the polymer A. The polymer A thus functions as a dispersant for the silicone segment, improving the dispersibility of the silicone segment in the toner. As a result, the silicon segment can suppress charge leakage from the polyester segment, resulting in good charge stability.

Because the polymer A is a crystalline resin, moreover, its viscosity declines during fixing in comparison with a polyester resin having the structure represented by the formula (B), and it is precipitated on the toner particle surface. Due to the presence of silicone segments with low surface free energy, the polymer A can melt and spread on the paper. If the formula (3) above (SP1−SP3<SP2−SP1) is satisfied, the hydrophobicity of the toner interior is greater relative to the second monomer unit of the polymer A, and the second monomer unit of the polymer A aligns more easily on the paper side, and can form a pseudo-crosslinked structure with the paper. The adhesiveness between the image and the paper increases as a result, and image scratch resistance is improved.

The polymer A has a first monomer unit having a structure represented by formula (I) below and a second monomer unit that is different from the first monomer unit. Moreover, the polymer A has crystalline segments derived from long-chain alkyl groups present in the first monomer unit. The first monomer unit derives from a first polymerizable monomer that is at least one selected from the group consisting of the (meth)acrylic acid esters having C₁₈₋₃₆ alkyl groups. If the carbon number is within this range, the polymer A has greater affinity for the silicone segment of a polyester resin having the structure represented by formula (B), and charge stability and image scratch resistance are improved. The first (or second) monomer unit is for example a monomer unit produced by addition polymerization (vinyl polymerization) of a first (or second) polymerizable monomer.

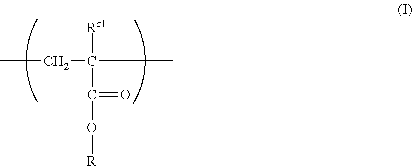

[In Formula (I), R^{Z1} represents a hydrogen atom or methyl group, and R represents a C₁₈₋₁₆ alkyl group (preferably a C₁₈₋₃₀ linear alkyl group).]

Examples of (meth)acrylic acid esters each having a C₁₈₋₃₆ alkyl group include (meth)acrylic acid esters each having a C₁₈₋₃₆ linear alkyl group [stearyl (meth)acrylate, nonadecyl (meth)acrylate, eicosyl (meth)acrylate, heneicosanyl (meth)acrylate, behenyl (meth)acrylate, lignoceryl (meth)acrylate, ceryl (meth)acrylate, octacosyl (meth)acrylate, myricyl (meth)acrylate, dotriacontyl (meth)acrylate, etc.] and (meth)acrylic acid esters each having a C₁₈₋₃₆ branched alkyl group [2-decyltetradecyl (meth)acrylate, etc.]. Of these, at least one selected from the group consisting of the (meth)acrylic acid esters having C₁₈₋₃₆ linear alkyl groups is preferred from the standpoint of low-temperature fixability, and at least one selected from the group consisting of the (meth) acrylic acid esters having C₁₈₋₃₀ linear alkyl groups is more preferred. At least one selected from the group consisting of linear stearyl (meth)acrylate and behenyl (meth)acrylate is still more preferred, and at least one selected from the group consisting of linear behenyl (meth)acrylate is yet more preferred. One kind of monomer alone or a combination of at least two kinds may be used for the first polymerizable monomer.

The content ratio of the first monomer unit in the polymer A is 5.0 mol % to 60.0 mol % or preferably 20.0 mol % to 40.0 mol % of the total molar amount of all monomer units in the polymer A. If the content ratio is within this range, charge stability is improved because the silicone segments can be dispersed in the toner, and image scratch resistance is improved because melting and spreading of the polymer A is promoted during fixing. The content ratio of the first monomer unit in the polymer A is preferably 40.0 mass % to 85.0 mass %, or more preferably 50.0 mass % to 80.0 mass %, or still more preferably 60.0 mass % to 75.0 mass %.

Given SP1 (J/cm³)^{0.5} as the SP value of the first monomer unit in the polymer A, the following formula (1) is satisfied. More preferably, the following formula (1)′ is satisfied.

SP1≤18.4 (1)

18.2≤SP1≤18.4 (1)′

The SP value here is an abbreviation for solubility parameter, which is an indicator of solubility. The calculation methods are described below. The SP value is given in units of (J/cm³)^{0.5} but can also be converted to units of (cal/cm³)^{0.5} using the formula 1 (cal/cm³)^{0.5}=2.045×10³ (J/cm³)^{0.5}. If the SP value of the first monomer unit is within this range, affinity between the first monomer unit and the silicone segment of a polyester resin having the structure represented by formula (B) is increased, resulting in better charge stability and image scratch resistance.

The polymer A also has a second monomer unit that is different from the first monomer unit. Given SP2 (J/cm³)^{0.5} as the SP value of the second monomer unit, the following formula (2) is satisfied. Preferably the following formula (2)′ is satisfied.

21.0≤SP2 (2)

25.0≤SP2≤30.0 (2)′

If the SP value of the second monomer unit is within this range, affinity between the second monomer unit and the polyester segment is increased, resulting in better charge stability as well as good image scratch resistance because crosslinked structures can form between the paper and the toner.

Given SP3 (J/cm³)^{0.5} as the SP value of the silicone segment (—(Si(R^{x})₂O)ₙ—Si(R^{x})₂—) in a polyester resin having the structure represented by formula (B), the following formula (3) is satisfied.

SP1−SP3≤SP2−SP1 (3)

If SP1, SP2 and SP3 satisfy the above formula, this means that the affinity between the first monomer unit and the silicone segment is greater than the affinity between the first monomer unit and the second monomer unit. If these conditions are satisfied, the dispersibility of the silicon segment in the toner is improved, resulting in good charge stability, and image scratch resistance is also improved because melting and spreading of the polymer A is promoted during fixing.

The content ratio of the second monomer unit in the polymer A is 20.0 mol % to 95.0 mol %, or preferably 30.0 mol % to 70.0 mol %, or still more preferably 40.0 mol % to 60.0 mol % based on the total molar amount of all monomer units in the polymer A. If the content ratio is within this range, affinity between the second monomer unit and the polyester segment is increased, resulting in good charge stability, while image scratch resistance is also improved because the second monomer unit can form crosslinked structures with the paper. The content ratio of the second monomer unit in the polymer A is preferably 10.0 mass % to 50.0 mass %, or more preferably 15.0 mass % to 40.0 mass %, or still more preferably 15.0 mass % to 30.0 mass %.

The second monomer unit is preferably at least one selected from the group consisting of the monomer units represented by formula (II) below and the monomer units represented by formula (III) below.

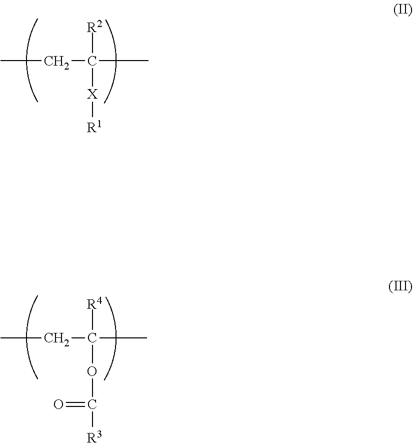

(In formula (II), X represents a single bond or C₁₋₆ alkylene group; R¹ is a nitrile group (—C≡N), amido group (—C(═O)NHR¹⁰, where R¹⁰ is a hydrogen atom or C₁₋₄ alkyl group), hydroxy group, —COOR¹¹ (where RH is a hydrogen atom, C₁₋₆ (preferably C₁₋₄) alkyl group or C₁₋₆ (preferably C₁₋₄) hydroxyalkyl group), urethane group (—NHCOOR¹², where R¹² is a C₁₋₄ alkyl group), urea group (—NH—C(═O)—N(R¹³)₂, where each of two R¹³ groups is independently a hydrogen atom or C₁₋₆ (preferably C₁₋₄) alkyl group), —COO(CH₂)₂NHCOOR¹⁴ (where R¹⁴ represents a C₁₋₄ alkyl group) or —COO(CH₂)₂—NH—C(═O)—N(R¹⁵)₂ (where each of two R² groups is independently a hydrogen atom or C₁₋₆ (preferably C₁₋₄) alkyl group); and R² represents a hydrogen atom or methyl group.) (In formula (III), R³ represents a C₁₋₄ alkyl group and R⁴ represents a hydrogen atom or methyl group.)

If the second monomer unit includes at least one selected from the group consisting of formula (II) and formula (III) above, affinity with the polyester segment is increased, resulting in good charge stability as well as good image scratch resistance because crosslinked structures can be formed with the paper. One kind alone or at least two kinds may be used for the second monomer unit. When at least two kinds of the first monomer unit are used together in the polymer A, the content ratio of the first monomer unit is a value that combines the content ratios of the individual monomer units. The same applies to the second monomer unit.

Of those, among examples listed below, a polymerizable monomer satisfying formula (2) and (3) may be used as the second polymerizable monomer for forming the second monomer unit. One kind of monomer alone or a combination of two or more kinds may be used as the second polymerizable monomer. Monomers having nitrile groups: for example, acrylonitrile, methacrylonitrile and the like. Monomers having hydroxy groups: for example, 2-hydroxyethyl (meth)acrylate, 2-hydroxypropyl (meth)acrylate and the like. Monomers having amido groups: for example, acrylamide and monomers obtained by reacting C₁₋₃₀ amines by known methods with C₂₋₃₀ carboxylic acids having ethylenically unsaturated bonds (acrylic acid, methacrylic acid, etc.).

Monomers having urethane groups: for example, monomers obtained by reacting C₂₋₂₂ alcohols having ethylenically unsaturated bonds (2-hydroxyethyl methacrylate, vinyl alcohol, etc.) by known methods with C₁₋₃₀ isocyanates [monoisocyanate compounds (benzenesulfonyl isocyanate, tosyl isocyanate, phenyl isocyanate, p-chlorophenyl isocyanate, butyl isocyanate, hexyl isocyanate, t-butyl isocyanate, cyclohexyl isocyanate, octyl isocyanate, 2-ethylhexyl isocyanate, dodecyl isocyanate, adamantyl isocyanate, 2,6-dimethylphenyl isocyanate, 3,5-dimethylphenyl isocyanate and 2,6-dipropylphenyl isocyanate, etc.), aliphatic diisocyanate compounds (trimethylene diisocyanate, tetramethylene diisocyanate, hexamethylene diisocyanate, pentamethylene diisocyanate, 1,2-propylene diisocyanate, 1,3-butylene diisocyanate, dodecamethylene diisocyanate and 2,4,4-trimethylhexamethylene diisocyanate, etc.), alicyclic diisocyanate compounds (1,3-cyclopentene diisocyanate, 1,3-cyclohexane diisocyanate, 1,4-cyclohexane diisocyanate, isophorone diisocyanate, hydrogenated diphenylmethane diisocyanate, hydrogenated xylylene diisocyanate, hydrogenated tolylene diisocyanate and hydrogenated tetramethylxylylene diisocyanate, etc.) and aromatic diisocyanate compounds (phenylene diisocyanate, 2,4-tolylene diisocyanate, 2,6-tolylene diisocyanate, 2,2′-diphenylmethane diisocyanate, 4,4′-diphenylmethane diisocyanate, 4,4′-toluidine diisocyanate, 4,4′-diphenyl ether diisocyanate, 4,4′-diphenyl diisocyanate, 1,5-naphthalene diisocyanate and xylylene diisocyanate, etc.) and the like], and monomers obtained by reacting C₁₋₂₆ alcohols (methanol, ethanol, propanol, isopropyl alcohol, butanol, t-butyl alcohol, pentanol, heptanol, octanol, 2-ethylhexanol, nonanol, decanol, undecyl alcohol, lauryl alcohol, dodecyl alcohol, myristyl alcohol, pentadecyl alcohol, cetanol, heptadecanol, stearyl alcohol, isostearyl alcohol, elaidyl alcohol, oleyl alcohol, linoleyl alcohol, linolenyl alcohol, nonadecyl alcohol, heneicosanol, behenyl alcohol, erucyl alcohol, etc.) by known methods with C₂₋₃₀ isocyanates having ethylenically unsaturated bonds [2-isocyanatoethyl (meth)acrylate, 2-(0-[1′-methylpropylidenamino]carboxyamino) ethyl (meth)acrylate, 2-[(3,5-dimethylpyrazolyl)carbonylamino]ethyl (meth)acrylate and 1,1-(bis(meth)acryloyloxymethyl) ethyl isocyanate, etc.] and the like.

Monomers having urea groups: for example, monomers obtained by reacting C₃₋₂₂ amines [primary amines (normal butylamine, t-butylamine, propylamine, isopropylamine, etc.), secondary amines (di-normal ethylamine, di-normal propylamine, di-normal butylamine, etc.), aniline, cycloxylamines and the like] by known methods with C₂₋₃₀ isocyanates having ethylenically unsaturated bonds and the like. Monomers having carboxyl groups: for example, methacrylic acid, acrylic acid, 2-carboxyethyl (meth)acrylate.

Of these, it is desirable to use a monomer having a nitrile, amide, urethane, hydroxy or urea group. More preferable is a monomer having an ethylenically unsaturated bond and at least one functional group selected from the group consisting of the nitrile, amide, urethane, hydroxy and urea groups.

The vinyl esters such as vinyl acetate, vinyl propionate, vinyl butyrate, vinyl caproate, vinyl caprylate, vinyl caprate, vinyl laurate, vinyl myristate, vinyl palmitate, vinyl stearate, vinyl pivalate and vinyl octylate can also be used by preference as the second polymerizable monomer.

The second polymerizable monomer preferably has an ethylenically unsaturated bond, and more preferably has one ethylenically unsaturated bond. Moreover, the second polymerizable monomer is more preferably at least one selected from the group consisting of the following formulae (C) and (D):

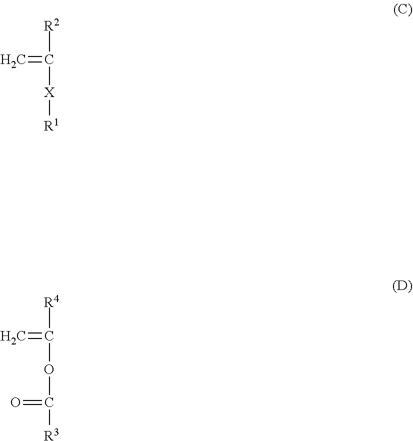

(In formula (C), X represents a single bond or C₁₋₆ alkylene group, R¹ is a nitrile group (—C≡N), amido group (—C(═O)NHR¹⁰, where R¹⁰ is a hydrogen atom or C₁₋₄ alkyl group), hydroxy group, —COOR¹¹ (where RH is a hydrogen atom, C₁₋₆ (preferably C₁₋₄) alkyl group or C₁₋₆ (preferably C₁₋₄) hydroxyalkyl group), urethane group (—NHCOOR¹², where R¹² is a C₁₋₄ alkyl group), urea group (—NH—C(═O)—N(R¹³)₂, where each of two R¹³ groups is independently a hydrogen atom or C₁₋₆ (preferably C₁₋₄) alkyl group), —COO(CH₂)₂NHCOOR¹⁴ (where R¹⁴ represents a C₁₋₄ alkyl group) or —COO(CH₂)₂—NH—C(═O)—N(R¹⁵)₂ (where each of two R¹⁵ groups is independently a hydrogen atom or C₁₋₆ (preferably C₁₋₄) alkyl group); and R² represents a hydrogen atom or methyl group.)

(In formula (D), R³ represents a C₁₋₄ alkyl group and R⁴ represents a hydrogen atom or methyl group.)

When multiple kinds of monomer units fulfilling the conditions for the first monomer unit are present in the polymer A, the value of SP1 in formula (3) is the weighted average value of the SP values of the individual monomer units. For example, if a monomer unit A with an SP value SP₁₁ is contained in the amount of A mol % based on the total molar amount of all monomer units fulfilling the conditions for the first monomer unit and a monomer unit B with an SP value SP₁₂ is contained in the amount of (100−A) mol % based on the total molar amount of all monomer units fulfilling the conditions for the first monomer unit, the SP value (SP1) is:

SP1=(SP₁₁×A+SP₁₂×(100×A))/100

A similar calculation is performed if at least three monomer units fulfilling the conditions for the first monomer unit are included. When multiple second monomer units and/or multiple silicone segments are present, SP2 and/or SP3 is determined in the same way as SP1 in the calculation of formula (3).

The polymer A is preferably a vinyl polymer. The vinyl polymer may be a polymer of a monomer containing an ethylenically unsaturated bond for example. An ethylenically unsaturated bond is a radical polymerizable carbon-carbon double bond, and examples include vinyl, propenyl, acryloyl and methacryloyl groups and the like. The acid value Av of the polymer A is preferably not more than 30.0 mg KOH/g, or more preferably not more than 20.0 mg KOH/g. There is no particular lower limit, but preferably it is at least 0 mg KOH/g. If the acid value is not more than 30.0 mg KOH/g, crystallization of the polymer A is not easily inhibited, and the melting is maintained well.

The weight-average molecular weight (Mw) of the tetrahydrofuran (THF)-soluble component of the polymer A as measured by gel permeation chromatography (GPC) is preferably from 10000 to 200000, or more preferably from 20000 to 150000. If the weight-average molecular weight (Mw) is within this range, it becomes easier to maintain elasticity near room temperature. The melting point of the polymer A is preferably from 50° C. to 80° C., or more preferably from 53° C. to 70° C. If the melting point is not less than 50° C., charge stability is good, while if it is not more than 80° C., image scratch resistance is improved.

As long as the molar ratio of the first monomer unit derived from the first polymerizable monomer and the second monomer unit derived from the second polymerizable monomer above is maintained, the polymer A may also contain may also contain a third monomer unit constituted from a third polymerizable monomer that does not fall within the scope of (1) or (2) above (that is, that is different from the first polymerizable monomer and the second polymerizable monomer). The third monomer unit is a structure obtained by addition polymerization of the third polymerizable monomer. Of the monomers mentioned as examples of the second polymerizable monomer, those that do not satisfy formula (2) above may be used as the third polymerizable monomer.

It is also possible to use the following monomers, which do not have nitrile, amide, urethane, hydroxy, urea or carboxyl groups: styrenes such as styrene and o-methylstyrene, and their derivatives, and (meth)acrylic acid esters such as methyl (meth)acrylate, n-butyl (meth)acrylate, t-butyl (meth)acrylate and 2-ethylhexyl (meth)acrylate. The third polymerizable monomer is preferably at least one selected from the group consisting of styrene, methyl methacrylate and methyl acrylate. When these monomers satisfy formula (2), they may be used as the second polymerizable monomer.

The content of the polymer A is preferably from 1.0 mass parts to 10.0 mass parts, or preferably from 3.0 mass parts to 8.0 mass parts per 100 mass parts of the binder resin. If the content of the polymer A is within this range, interactions between the polymer A and a polyester resin having the structure represented by formula (B) are promoted, resulting in improved charge stability and image scratch resistance.

It is especially desirable that the first monomer unit be a monomer unit derived from behenyl acrylate. That is, it is especially desirable that R^{Z1} be a hydrogen atom while R is a C₂₂ alkyl group in formula (I). Using behenyl acrylate, the silicone segments of the polyester resin having the structure represented by formula (B) are dispersed in the toner, further improving charge stability, while the effect of melting and spreading the polymer A during fixing is also obtained, further improving image scratch resistance.

The polyester resin having the structure represented by formula (B) has a silicone segment represented by —(Si(R^{x})₂O)ₘ—Si(R^{x})₂—. That is, the polyester resin having the structure represented by formula (B) has a silicone segment represented by formula (B′) below. The content of the silicone segment in the polyester resin having the structure represented by formula (B) is preferably from 0.5 mass % to 5.0 mass %, or more preferably from 2.0 mass % to 4.0 mass %. If the content of the silicone segment is within this range, dispersibility of the silicone segments in the toner is improved by interactions with the polymer A, and melting and spreading of the polymer A is also promoted because the surface free energy is effectively lowered during fixing.

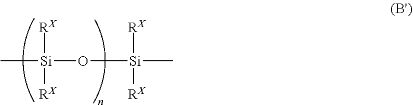

In formula (B′), RX and n are as in formula (B). Each R^{x} is independently a hydrogen atom, methyl group or phenyl group. n is the average number of repetitions of the siloxane unit and is an integer from 10 to 80 (preferably from 20 to 65). In formula (B) and formula (B′), all of R^{x} groups are preferably methyl groups. This increases the affinity between the polymer A and the first monomer unit, further improving charge stability and image scratch resistance.

The binder resin used in the toner is explained. The binder resin contains a polyester resin having a structure represented by formula (B). The binder resin may also contain another resin in addition to the polyester resin having the structure represented by formula (B). Examples of the other resin include polyester resins, polyurethane resins, epoxy resins and phenol resins, as well as hybrid resins including at least two of these resins bound together. The content of the polyester resin having the structure represented by formula (B) in the binder resin is preferably at least 50 mass %, or at least 70 mass %, or at least 80 mass %, or at least 90 mass %, or at least 95 mass %. There is no particular upper limit, but preferably it is not more than 100 mass %. These numbers may be combined arbitrarily. Effective interactions with the polymer A described above can be obtained if the polyester resin having the structure represented by formula (B) is the principal component of the binder resin.

The polyester resin having the structure represented by formula (B) has a silicone segment represented by formula (B′) and a polyester segment. The polyester segment of the polyester resin having the structure represented by formula (B) is preferably an amorphous polyester resin segment. The components constituting the polyester segment of the polyester resin having the structure represented by formula (B) are described in detail. The following components may be used alone or in combinations of at least two depending on the type and application. The dibasic carboxylic acid component constituting the polyester segment can be exemplified by the following dicarboxylic acids and their derivatives: benzenedicarboxylic acids and their anhydrides and lower alkyl esters, e.g., phthalic acid, terephthalic acid, isophthalic acid, and phthalic anhydride; alkyl dicarboxylic acids, e.g., succinic acid, adipic acid, sebacic acid, and azelaic acid, and their anhydrides and lower alkyl esters; alkenylsuccinic acids and alkylsuccinic acids having an average value for the number of carbons of from 1 to 50, and their anhydrides and lower alkyl esters; and unsaturated dicarboxylic acids, e.g., fumaric acid, maleic acid, citraconic acid, and itaconic acid, and their anhydrides and lower alkyl esters.

The dihydric alcohol component constituting the polyester segment, on the other hand, can be exemplified by the following: ethylene glycol, polyethylene glycol, 1,2-propanediol, 1,3-propanediol, 1,3-butanediol, 1,4-butanediol, 2,3-butanediol, diethylene glycol, triethylene glycol, 1,5-pentanediol, 1,6-hexanediol, neopentyl glycol, 2-methyl-1,3-propanediol, 2-ethyl-1,3-hexanediol, 1,4-cyclohexanedimethanol (CHDM), hydrogenated bisphenol A, bisphenols given by formula (I-1) and derivatives thereof, and diols given by formula (I-2).

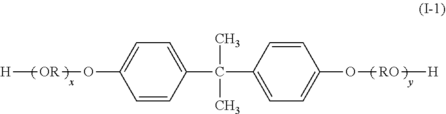

In formula, R represents the ethylene group or propylene group, x and y are each integers equal to or greater than 0, and the average value of x+y is from 0 to 10.

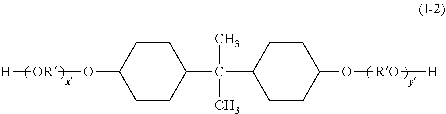

In formula, R′ represents the ethylene group or propylene group, x′ and y′ are each integers equal to or greater than 0, and the average value of x′+y′ is from 0 to 10.

Apart from the divalent carboxylic acid component and dihydric alcohol component described above, an at least trivalent carboxylic acid component and an at least trihydric alcohol component may also be included as constituent components of the polyester segment. The at least trivalent carboxylic acid component is not particularly limited, but examples include trimellitic acid, trimellitic anhydride, pyromellitic acid and the like. Examples of the at least trihydric alcohol component include trimethylol propane, pentaerythritol, glycerin and the like.

Apart from the compounds described above, a monovalent carboxylic acid component and a monohydric alcohol component may be included as constituent components of the polyester segment. Specific examples of the monovalent carboxylic acid component include palmitic acid, stearic acid, arachidic acid, behenic acid, cerotic acid, heptacosanoic acid, montanic acid, melissic acid, lacceric acid, tetracontanoic acid and pentacontanoic acid. Examples of the monohydric alcohol include behenyl alcohol, ceryl alcohol, melissyl alcohol and tetracontanol. The content of the polyester segment in the polyester resin having the structure represented by formula (B) is preferably from 95.0 mass % to 99.5 mass %, or more preferably from 96.0 mass % to 98.0 mass %.

The components constituting the silicone segment of the polyester resin having the structure represented by formula (B) are explained in detail. The following components may be used alone or in combinations of at least two depending on the type and application. The silicone segment has a structure (—(Si(R^{x})₂O)ₙ—Si(R^{x})₂—) represented by formula (B′) above. A silicone oil including a functional group that reacts chemically with polyester at the terminus of formula (B′) may be used as a component for forming the silicone segment on the polyester resin having the structure represented by formula (B). Examples of functional groups that react with polyester include hydroxy, carboxy, epoxy and amino groups and the like.

For purposes of controlling reactivity with the polyester, the functional group at the terminus of the silicone oil is preferably a hydroxy group or carboxy group. In terms of valence, the functional group of the silicone oil is preferably monovalent, divalent, or at least trivalent. Because interactions with the polymer A are controlled and charge stability and image scratch resistance are improved by introducing silicone segments into the main polyester skeleton, a divalent silicone oil having functional groups at both ends is preferred. A silicone oil having substituents containing hydroxy groups at both ends of formula (B′) is more preferred. An example of a substituent containing a hydroxy group is represented by:

—(CH₂)ₚ—O—(CH₂)_{q}—OH

In the formula, p is an integer from 1 to 3 and q is an integer from 1 to 3.

The method for manufacturing the polyester resin having the structure represented by formula (B) is not particularly limited, and a known method may be used. For example, the divalent carboxylic acid component and dihydric alcohol component described above may be polymerized together with a silicone oil having a functional group via an esterification reaction or ester-exchange reaction and a condensation reaction to manufacture the polyester resin having the structure represented by formula (B). The polymerization temperature is not particularly limited, but is preferably in the range of from 180° C. to 290° C. A polymerization catalyst such as a titanium catalyst or tin catalyst or zinc acetate, antimony trioxide, germanium dioxide or the like may be used when polymerizing the polyester resin. The softening point of the polyester resin having the structure represented by formula (B) is preferably from 85° C. to 150° C., or more preferably from 100° C. to 150° C. If the softening point of the polyester resin having the structure represented by formula (B) is within this range, charge stability is improved, and image scratch resistance is also better.

The toner may also contain a wax. Examples of the wax include the following: hydrocarbon waxes such as low-molecular-weight polyethylene, low-molecular-weight polypropylene, alkylene copolymers, microcrystalline wax, paraffin wax and Fischer-Tropsch wax; hydrocarbon wax oxides such as polyethylene oxide wax, and block copolymers of these; waxes such as carnauba wax consisting primarily of fatty acid esters; and partially or fully deoxidized products of fatty acid esters, such as deoxidized carnauba wax. Of these waxes, a hydrocarbon wax such as paraffin wax or Fischer-Tropsch wax or a fatty acid ester wax such as carnauba wax is preferred for improving low-temperature fixability and hot offset resistance.

The wax is preferably used in the amount of from 1.0 mass parts to 20.0 mass parts per 100 mass parts of the binder resin. In an endothermic curve obtained during temperature rise by differential scanning calorimetry (DSC), the peak temperature (melting point) of the maximum endothermic peak of the wax in the temperature range of from 30° C. to 200° C. is preferably from 50° C. to 140° C., or more preferably from 60° C. to 105° C.

The toner may also use a colorant. Examples of colorants include the following. Examples of black colorants include carbon black and blacks obtained by blending yellow, magenta and cyan colorants. A pigment may be used alone as a colorant, but combining a dye and a pigment to improve the sharpness is desirable from the standpoint of the image quality of full-color images. Examples of pigments for magenta toners include C.I. pigment red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48:2, 48:3, 48:4, 49, 50, 51, 52, 53, 54, 55, 57:1, 58, 60, 63, 64, 68, 81:1, 83, 87, 88, 89, 90, 112, 114, 122, 123, 146, 147, 150, 163, 184, 202, 206, 207, 209, 238, 269 and 282; C.I. pigment violet 19; and C.I. vat red 1, 2, 10, 13, 15, 23, 29 and 35. Examples of dyes for magenta toners include C.I. solvent red 1, 3, 8, 23, 24, 25, 27, 30, 49, 81, 82, 83, 84, 100, 109 and 121; C.I. disper red 9; C.I. solvent violet 8, 13, 14, 21, 27; oil-soluble dyes such as C.I. disper violet 1, and C.I. basic red 1, 2, 9, 12, 13, 14, 15, 17, 18, 22, 23, 24, 27, 29, 32, 34, 35, 36, 37, 38, 39 and 40; and basic dyes such as C.I. basic violet 1, 3, 7, 10, 14, 15, 21, 25, 26, 27 and 28.

Examples of pigments for cyan toners include C.I. pigment blue 2, 3, 15:2, 15:3, 15:4, 16, and 17; C. I. vat blue 6; and C.I. acid blue 45 and copper phthalocyanine pigments having 1 to 5 phthalimidomethyl substituents in the phthalocyanine framework. Examples of dyes for cyan toners include C.I. solvent blue 70. Examples of pigments for yellow toners include C.I. pigment yellow 1, 2, 3, 4, 5, 6, 7, 10, 11, 12, 13, 14, 15, 16, 17, 23, 62, 65, 73, 74, 83, 93, 94, 95, 97, 109, 110, 111, 120, 127, 128, 129, 147, 151, 154, 155, 168, 174, 175, 176, 180, 181 and 185; and C.I. vat yellow 1, 3 and 20. Examples of dyes for yellow toners include C.I. solvent yellow 162. The content of the colorant is preferably from 0.1 to 30 mass parts per 100 mass parts of the binder resin.

A charge control agent may also be included in the toner as necessary. Examples of negative charge control agents include salicylic acid metal compounds, naphthoic acid metal compounds, dicarboxylic acid metal compounds, polymeric compounds having sulfonic acids or carboxylic acids in the side chains, polymeric compounds having sulfonic acid salts or sulfonic acid esters in the side chains, polymeric compounds having carboxylic acid salts or carboxylic acid esters in the side chains, and boron compounds, urea compounds, silicon compounds and calixarenes. The charge control agent may be added either internally or externally to the toner particle. The added amount of the charge control agent is preferably 0.1 mass parts to 10 mass parts per 100 mass parts of the binder resin.

An inorganic fine particle may be contained in the toner as necessary. The inorganic fine particle may be added internally to the toner particle or mixed in with the toner particle as an external additive. An inorganic fine particle such as a silica, titanium oxide, strontium titanate or aluminum oxide particle is preferred as an external additive. A low-resistance particle such as a silica or strontium titanate particle is more preferred from the standpoint of developing stability. The inorganic fine particle is preferably one that has been hydrophobically treated with a hydrophobic agent such as a silane compound or silicone oil or a mixture of these.

For purposes of improving flowability, the external additive is preferably an inorganic fine powder with a specific surface area of from 50 m²/g to 400 m²/g, while for purposes of stabilizing durability an inorganic fine powder with a specific surface area of from 10 m²/g to 50 m²/g is preferred. Inorganic fine particles with specific surface areas within these ranges can be used together to both improve flowability and stabilize durability. The content of the external additive is preferably from 0.1 mass parts to 10.0 mass parts per 100 mass parts of the toner particle. A known mixing apparatus such as a Henschel mixer may be used for mixing the toner particle with the external additive.

The toner may be used as a one-component developer, but to obtain stable images over a long period of time, it is preferably mixed with a magnetic carrier and used as a two-component developer. A common, well-known magnetic carrier may be used, and examples include surface oxidized iron powders, unoxidized iron powders, metal particles of iron, lithium, calcium, magnesium, nickel, copper, zinc, cobalt, manganese, rare earths and the like, alloy particles and oxide particles of these, magnetic bodies such as ferrite, and resin carriers with dispersed magnetic bodies (so-called resin carriers) comprising binders resins carrying these magnetic bodies in a dispersed state. When the toner is mixed with a magnetic carrier and used as a two-component developer, good effects can normally be obtained if the carrier mixing ratio (toner concentration of the two-component developer) is from 2 mass % to 15 mass %, or more preferably from 4 mass % to 13 mass %.

Manufacturing Method

The method for manufacturing the toner particle is not particularly limited, and a conventional known emulsion aggregation method, melt kneading method, dissolution suspension method or the like may be used as the manufacturing method. The resulting toner particle may be used as is as a toner. An external additive may also be mixed (externally added) with the resulting toner particle to obtain a toner. Examples of the external additive include inorganic fine particles of silica, alumina, titania, calcium carbonate and the like and resin particles of vinyl resin, polyester resin, silicone resin and the like. These inorganic fine powders and resin particles function as external additives such as charge control agents, fluidity improvers and cleaning aids. The mixing apparatus may be a double cone mixer, V mixer, drum mixer, Super mixer, Henschel mixer, Nauta mixer, Mechano Hybrid (Nippon Coke & Engineering) or the like.

A specific example of a method for manufacturing the toner by a melt kneading method is described below, but the method is not limited thereby.

### Melt Kneading Method

First, in a raw material mixing step, the binder resin and the polymer A together with a wax, colorant and other additives and the like as necessary are weighed, compounded and mixed in predetermined amounts as toner raw materials. The apparatus used for mixing may be a Henschel Mixer (Nippon Coke & Engineering); a Super mixer (Kawata); a Ribocone (Okawara Mfg.); a Nauta mixer, Turbulizer or Cyclomix (Hosokawa Micron); a spiral pin mixer (Pacific Machinery & Engineering); or a Loedige mixer (Matsubo) or the like.

The resulting mixture is then melted and kneaded to melt the binder resin and dispersed the polymer A therein (melt kneading step). The apparatus used in the melt kneading step may be a TEM extruder (Toshiba Machine), a TEX twin-screw kneader (Japan Steel Works), a PCM kneader (Ikegai), a Kneadex (Mitsui Mining) or the like. A continuous kneading apparatus such as a single-screw or twin-screw extruder is preferred over a batch kneader because it is advantageous for continuous production and the like. The melt kneaded product is then rolled between twin rolls or the like and cooled by water cooling or the like.

The cooled product is pulverized to the desired particle size. First it is crushed with a crusher, hammer mill, feather mill or the like, and the finely pulverized with a Cryptron System (Kawasaki Heavy Industries), Super Rotor (Nisshin Engineering) or the like to obtain a resin particle. The resulting resin particle may be classified to the desired particle size to obtain a toner particle. The apparatus used for classification may be a Turboplex, Faculty, TSP or TTSP (Hosokawa Micron) or an Elbow-Jet (Nittetsu Mining) or the like.

The methods for measuring the various physical properties are explained next.

### Method for Measuring Content Ratio of Each Monomer Unit in Polymer A

The contents of the monomer units derived from each polymerizable monomer in the polymer A are measured by ¹H-NMR under the following conditions.
Measurement unit: FT NMR unit JNM-EX400 (JEOL Ltd.)
Measurement frequency: 400 MHz
Pulse condition: 5.0
Frequency range: 10500 Hz
Number of integrations: 64
Measurement temperature: 30° C.
Sample: Prepared by placing 50 mg of the measurement sample in a sample tube with an inner diameter of 5 mm, adding deuterated chloroform (CDCl₃) as a solvent, and dissolving this in a thermostatic tank at 40° C.

Of the peaks attributable to constituent elements of the first monomer unit in the resulting ¹H-NMR chart, a peak independent of peaks attributable to constituent elements of otherwise-derived monomer units is selected, and the integrated value S ₁ of this peak is calculated. Similarly, a peak independent of peaks attributable to constituent elements of otherwise-derived monomer units is selected from the peaks attributable to constituent elements of the second monomer unit, and the integrated value S₂ of this peak is calculated. When a third monomer unit is contained, a peak independent of peaks attributable to constituent elements of otherwise-derived monomer units is selected from the peaks attributable to constituent elements of the third monomer unit, and the integrated value S₃ of this peak is calculated.

The content of the first monomer unit is determined as follows using the integrated values S₁, S₂ and S₃. n₁, n₂ and n₃ are the numbers of hydrogen atoms in the constituent elements to which the observed peaks are attributed for each segment.

Content (mol %) of the first monomer unit=

{(S₁/n₁)/((S₁/n₁)+(S₂/n₂)+(S₃/n₃))}×100.

Content (mol %) of the second monomer unit and the third monomer unit is determined similarly as shown below.

Content (mol %) of the second monomer unit=

{(S_{2/}n₂)/((S₁/n₁)+(S₂/n₂)+(S₃/n₃))}×100.

Content (mol %) of the third monomer unit=

{(S₃/n₃)/((S₁/n₁)+(S₂/n₂)+(S₃/n₃))}×100.

When a polymerizable monomer not containing a hydrogen atom in a constituent element other than a vinyl group is used in the polymer A, measurement is performed in single pulse mode using ¹³C-NMR with ¹³C as the measurement nucleus, and the ratio is calculated in the same way as by ¹H-NMR. When the toner is manufactured by suspension polymerization, independent peaks may not be observed because the peaks of release agents and other resins overlap. It may thus be impossible to calculate the ratios of the monomer units derived from each of the polymerizable monomers in the polymer A. In this case, a polymer A′ can be manufactured and analyzed as the polymer A by performing similar suspension polymerization without using a release agent or other resin.

Method for Calculating SP Value

SP value such as SP1 and SP2 is determined as follows following the calculation methods proposed by Fedors. The evaporation energy (Δei) (cal/mol) and molar volume (Δvi) (cm³/mol) are determined from the tables described in “Polym. Eng. Sci., 14(2), 147-154 (1974)” for the atoms or atomic groups in the molecular structures of each of the polymerizable monomers, and (4.184×ΣΔei/ΣΔvi)^{0.5} is regarded as the SP value (J/cm³)^{0.5}. SP1 and SP2 are calculated by the above methods for the atoms or atomic groups in the molecular structures of the same polymerizable monomers with the double bonds cleaved by polymerization.

Measuring Glass Transition Temperature (Tg) of Binder Resin and Melting Peak Temperature (Melting Point) of Polymer A

The Tg values and melting points of the resins including the binder resin and polymer A are measured with a Q2000 differential scanning calorimeter (TA Instruments) in accordance with ASTM D3418-82. The melting points of indium and zinc are used for temperature correction of the device detector, and the heat of fusion of indium is used to correct the calorific value. Specifically, about 3 mg of resin is weighed exactly, placed in an aluminum pan and measured under the following conditions using an empty aluminum pan for reference.

Ramp rate: 10° C./min

Measurement start temperature: 30° C.

Measurement end temperature: 180° C.

Measurement is performed at a ramp rate of 10° C./minute within the measurement range of 30° C. to 180° C. After the temperature reaches 180° C. it is maintained for 10 minutes, then reduced to 30° C., and then raised again. A change in specific heat is obtained within the temperature range of 30° C. to 100° C. during this second temperature rise. The point of intersection between the differential thermal curve and a line midway between the baselines before and after the occurrence of the specific heat change is defined as the glass transition temperature (Tg) of the resin. The temperature at the maximum endothermic peak of the temperature-heat absorption curve in the range of 40° C. to 90° C. is defined as the melting peak temperature (Tp).

Method for Measuring Softening Point Tm

The softening point is measured using a “Flowtester CFT-500D Flow Property Evaluation Instrument” (Shimadzu Corporation), which is a constant-load extrusion-type capillary rheometer, in accordance with the manual provided with the instrument. With this instrument, while a constant load is applied by a piston from the top of the measurement sample, the measurement sample filled in a cylinder is heated and melted and the melted measurement sample is extruded from a die at the bottom of the cylinder; a flow curve showing the relationship between piston stroke and temperature can be obtained from this. The “melting temperature by the ½ method”, as described in the manual provided with the “Flowtester CFT-500D Flow Property Evaluation Instrument”, is used as the softening point. The melting temperature by the ½ method is determined as follows. First, ½ of the difference between the piston stroke Smax at the completion of outflow and the piston stroke Smin at the start of outflow is determined (this value is designated as X, where X=(Smax−Smin)/2). The temperature in the flow curve when the piston stroke in the flow curve reaches the sum of X and Smin is the melting temperature by the ½ method.

The measurement sample used is prepared by subjecting approximately 1.3 g of the sample to compression molding for 60 seconds at 10 MPa in a 25° C. environment using a tablet compression molder (for example, NT-100H, NPa System Co., Ltd.) to provide a cylindrical shape with a diameter of approximately 8 mm. The measurement conditions with the CFT-500D are as follows.
test mode: ramp-up method
start temperature: 50° C.
saturated temperature: 200° C.
measurement interval: 1.0° C.
ramp rate: 4.0° C./min
piston cross section area: 1.000 cm²
test load (piston load): 10.0 kgf/cm² (0.9807 MPa)
preheating time: 300 seconds
diameter of die orifice: 1.0 mm
die length: 1.0 mm

Measuring Molecular Weight of Polymer A by GPC

The molecular weight (Mw) of the THF-soluble component of the polymer A is measured as follows by gel permeation chromatography (GPC). First, the sample is dissolved in tetrahydrofuran (THF) over the course of 24 hours at room temperature. The resulting solution is filtered through a solvent-resistant membrane filter (Maishori Disk, Tosoh Corp.) having a pore diameter of 0.2 μm to obtain a sample solution. The concentration of THF-soluble components in the sample solution is adjusted to about 0.8 mass %. Measurement is performed under the following conditions using this sample solution.
System: HLC8120 GPC (detector: RI) (Tosoh Corp.)
Columns: Shodex KF-801, 802, 803, 804, 805, 806, 807 (total 7) (Showa Denko)
Eluent: Tetrahydrofuran (THF)
Flow rate: 1.0 mL/min
Oven temperature: 40.0° C.
Sample injection volume: 0.10 mL

A molecular weight calibration curve prepared using standard polystyrene resin (product name: TSK standard polystyrene F-850, F-450, F-288, F-128, F-80, F-40, F-20, F-10, F-4, F-2, F-1, A-5000, A-2500, A-1000, A-500, Tosoh Corp.) is used for calculating the molecular weights of the samples.

Measuring Acid Value of Polymer A

The acid value is the number of mg of potassium hydroxide needed to neutralize the acid contained in 1 g of sample. The acid value of the polymer A is measured in accordance with JIS K 0070-1992, and the specific measurement procedures are as follows.

### (1) Reagent Preparation

A phenolphthalein solution is obtained by dissolving 1.0 g of phenolphthalein in 90 mL of ethyl alcohol (95 vol%) and adding ion-exchanged water to a total of 100 mL. 7 g of special-grade potassium hydroxide is dissolved in 5 mL of water, and this is brought to 1 L by addition of ethyl alcohol (95 vol%). This is placed in an alkali-resistant container while avoiding contact with carbon dioxide and the like, allowed to stand for 3 days, and filtered to obtain a potassium hydroxide solution. The resulting potassium hydroxide solution is stored in an alkali-resistant container. The factor of this potassium hydroxide solution is determined from the amount of the potassium hydroxide solution required for neutralization when 25 mL of 0.1 mol/L hydrochloric acid is placed in an Erlenmeyer flask, several drops of the phenolphthalein solution are added, and titration is performed with the potassium hydroxide solution. The 0.1 mol/L hydrochloric acid is prepared in accordance with JIS K 8001-1998.

### (2) Operations

### (A) Main Test

2.0 g of a pulverized sample of the polymer A is weighed exactly into a 200 mL Erlenmeyer flask, 100 mL of a toluene:ethanol (2:1) mixed solution is added, and the sample is dissolved over the course of 5 hours. Several drops of the phenolphthalein solution are then added as an indicator, and titration is performed using the potassium hydroxide solution. The titration endpoint is taken to be persistence of the faint pink color of the indicator for 30 seconds.

### (B) Blank Test

Titration is performed by the same procedures, but without using any sample (that is, with only the toluene:ethanol (2:1) mixed solution).

### (3) The Acid Value is Calculated by Substituting the Obtained Results Into the Following Formula:

A=[(C−B)×f×5.61]/S

where A is the acid value (mg KOH/g), B is the added amount (mL) of the potassium hydroxide solution in blank test, C is the added amount (mL) of the potassium hydroxide solution in main test, f is the factor of the potassium hydroxide solution, and S is the mass of the sample (g).

Measuring Weight-Average Particle Diameter (D4) of Toner Particle

Using a Multisizer (registered trademark) 3 Coulter Counter precise particle size distribution analyzer (Beckman Coulter, Inc.) based on the pore electrical resistance method and equipped with a 100 μm aperture tube, together with the accessory dedicated Beckman Coulter Multisizer 3 Version 3.51 software (Beckman Coulter, Inc.) for setting measurement conditions and analyzing measurement data, measurement is performed with 25,000 effective measurement channels, and the measurement data are analyzed to calculate the weight-average particle diameter (D4) of the toner particle. The aqueous electrolyte solution used in measurement may be a solution of special grade sodium chloride dissolved in ion-exchanged water to a concentration of about 1 mass %, such as ISOTON II (Beckman Coulter, Inc.) for example. The dedicated software settings are performed as follows prior to measurement and analysis.

On the “Standard measurement method (SOM) changes” screen of the dedicated software, the total count number in control mode is set to 50,000 particles, the number of measurements to 1, and the Kd value to a value obtained with “standard particles 10.0μm” (Beckman Coulter, Inc.). The threshold noise level is set automatically by pushing the “Threshold/Noise Level measurement button”. The current is set to 1600 μA, the gain to 2, and the electrolyte solution to ISOTON II, and a check is entered for aperture tube flush after measurement. On the “Conversion settings from pulse to particle diameter” screen of the dedicated software, the bin interval is set to the logarithmic particle diameter, the particle diameter bins to 256, and the particle diameter range to from 2 μm to 60 μm.

The specific measurement methods are as follows.

(1) About 200 mL of the aqueous electrolyte solution is added to a dedicated 250 mL round-bottomed beaker of the Multisizer 3, the beaker is set on the sample stand, and stirring is performed with a stirrer rod counter-clockwise at a rate of 24 rotations/second. Contamination and bubbles in the aperture tube are then removed by the “Aperture tube flush” function of the dedicated software.

(2) 30 mL of the same aqueous electrolyte solution is placed in a glass 100 mL flat-bottomed beaker, and about 0.3 mL of a dilution of “Contaminon N” (a 10 mass % aqueous solution of a pH 7 neutral detergent for washing precision instruments, comprising a nonionic surfactant, an anionic surfactant, and an organic builder, manufactured by Wako Pure Chemical Industries) diluted 3× by mass with ion-exchanged water is added.

(3) A specific amount of ion-exchanged water is placed in the water tank of an ultrasonic disperser (Ultrasonic Dispersion System Tetora 150, Nikkaki Bios) with an electrical output of 120 W equipped with two built-in oscillators having an oscillating frequency of 50 kHz with their phases shifted by 180° from each other, and about 2 mL of the Contaminon N is added to this water tank.

(4) The beaker of (2) above is set in the beaker-fixing hole of the ultrasonic disperser, and the ultrasonic disperser is operated. The height position of the beaker is adjusted so as to maximize the resonant condition of the liquid surface of the aqueous electrolyte solution in the beaker.

(5) The aqueous electrolyte solution in the beaker of (4) is exposed to ultrasound as about 10 mg of toner particle is added bit by bit to the aqueous electrolyte solution, and dispersed. Ultrasound dispersion is then continued for a further 60 seconds. During ultrasound dispersion, the water temperature in the tank is adjusted appropriately to from 10° C. to 40° C.

(6) The aqueous electrolyte solution of (5) with the toner dispersed therein is dripped with a pipette into the round-bottomed beaker of (1) set on the sample stand, and adjusted to a measurement concentration of about 5%. Measurement is then performed until the number of measured particles reaches 50,000.

(7) The measurement data is analyzed with the dedicated software attached to the apparatus, and the weight-average particle diameter (D4) is calculated. The weight-average particle diameter (D4) is the “Average diameter” on the “Analysis/volume statistical value (arithmetic mean)” screen when Graph/vol % is set in the dedicated software.

Method for Separating Materials from Toner

Each of the materials contained in the toner can be separated from the toner using differences in the solubility of the individual materials in solvents.

First separation: The toner is dissolved in 23° C. methyl ethyl ketone (MEK) and separated into a soluble component (polyester resin having structure of formula (B)) and an insoluble component (polymer A, wax, colorant, inorganic fine particle, etc.).

Second separation: The insoluble component obtained in the first separation (polymer A, wax, colorant, inorganic fine particle, etc.) is dissolved in 100° C. MEK, and separated into a soluble component (polymer A, wax) and an insoluble component (colorant, inorganic fine particle, etc.).

Third separation: The soluble component obtained in the second separation (polymer A, wax) is dissolved in 23° C. chloroform and separated into a soluble component (polymer A) and an insoluble component (wax).

The individual materials can be analyzed and the contents of the materials can be calculated based on these separations.

Confirming Structure of Polyester Resin Having Structure Represented by Formula (B)

The following methods are used to confirm the structure of the polyester resin having the structure represented by formula (B). The hydrocarbon group of R^{x} and the silicone segment in the formula (B) are confirmed by ¹³C-NMR and solid ²⁹Si-NMR. (¹³C-NMR measurement conditions)
instrument: JNM-ECX500II, JEOL RESONANCE
sample tube: 3.2 mmΦ
sample: deuterochloroform-soluble matter from sample for NMR measurement
measurement temperature: room temperature
pulse mode: CP/MAS
measurement nucleus frequency: 123.25 MHz (¹³C)
reference substance: adamantane (external reference: 29.5 ppm)
sample spinning rate: 20 kHz
contact time: 2 ms
delay time: 2 s
number of scans: 1024

In this method, the hydrocarbon group represented by the R^{X} in formula (B) is identified by the presence/absence of signal originating with, e.g., the silicon atom-bonded methyl group (Si—CH₃) or phenyl group (Si—C₆H₅).

The specific measurement conditions for the solid-state ²⁹Si-NMR are as follows.
instrument: JNM-ECX5002 (JEOL RESONANCE)
temperature: room temperature
measurement method: DD/MAS method, ²⁹Si, 45°
sample tube: zirconia 3.2 mmΦ
sample: filled as a powder into the sample tube
sample spinning rate: 10 kHz
relaxation delay: 180 s
scans: 2000

Measuring Content of Silicone Segment in Polyester Resin Having Structure Represented by Formula (B)

The content of the polymer A and the content of the silicone segment in the polyester resin having the structure represented by formula (B) are confirmed by ¹H-NMR using the apparatus described above.

### ¹H-NMR Measurement Conditions

Sample: Deuterated chloroform-soluble component

Pulse condition: 5.0 μs

Frequency range: 10500 Hz

Cumulative number: 64

### EXAMPLES

The present invention is explained in detail below based on examples, but the invention is not limited by these examples. Unless otherwise specified, parts in the formulations below are based on mass.

Manufacturing Example of Binder Resin P1
Bisphenol A ethylene oxide (2.2 mol adduct): 50.0 moles
Bisphenol A propylene oxide (2.2 mol adduct): 50.0 moles
Terephthalic acid: 90.0 moles
Trimellitic anhydride: 10.0 moles

97 parts of these monomers for forming the polyester segment and 3 parts of a silicone oil having hydroxy groups at both ends (KF-6001, Shinetsu Chemical) were mixed in a 5-liter autoclave together with 500 ppm of titanium tetrabutoxide. A reflux cooler, moisture separator, N₂ gas introduction pipe, thermometer and stirrer were attached, and a polycondensation reaction was performed at 230° C. as N₂ gas was introduced into the autoclave. The reaction time was adjusted to obtain the desired softening point, and the product was removed from the container after completion of the reaction, cooled, and pulverized to obtain a binder resin P1. The content of the silicone segment in the binder resin P1 was 3.0 mass %. The physical properties are shown in Table 1.

Manufacturing Examples of Binder Resins P2 to P8

Binder resins P2 to P8 were obtained as in the manufacturing example of the binder resin P1 except that the added amount of the silicone oil was changed so that the content of the silicone segment was as shown in Table 1, and the Tm and Tg were changed by adjusting the reaction time.

TABLE 1

| | | | | | | | | | Silicone | | | Physical | |
|---|---|---|---|---|---|---|---|---|---|---|---|---|---|
| | Alcohol | | Alcohol | | | | | | segment | | | properties | |
| Binder | component | | component | | Carboxylic acid component | | | | (silicone oil) | | | Tg | Tm |
| resin | Type | Moles | Type | Moles | Type | Moles | Type | Moles | Type | Mass % | SP3 | [° C.] | [° C.] |
| P1 | BPA-PO | 50.0 | BPA-EO | 50.0 | TPA | 90.0 | TMA | 10.0 | KF-6001 | 3.0 | 15.6 | 55 | 130 |
| P2 | BPA-PO | 50.0 | BPA-EO | 50.0 | TPA | 90.0 | TMA | 10.0 | KF-6001 | 4.0 | 15.6 | 53 | 128 |
| P3 | BPA-PO | 50.0 | BPA-EO | 50.0 | TPA | 90.0 | TMA | 10.0 | KF-6001 | 2.0 | 15.6 | 56 | 136 |
| P4 | BPA-PO | 50.0 | BPA-EO | 50.0 | TPA | 90.0 | TMA | 10.0 | KF-6001 | 0.5 | 15.6 | 58 | 135 |
| P5 | BPA-PO | 50.0 | BPA-EO | 50.0 | TPA | 90.0 | TMA | 10.0 | KF-6001 | 5.0 | 15.6 | 58 | 143 |
| P6 | BPA-PO | 50.0 | BPA-EO | 50.0 | TPA | 90.0 | TMA | 10.0 | KF-6001 | 6.0 | 15.6 | 56 | 140 |
| P7 | BPA-PO | 50.0 | BPA-EO | 50.0 | TPA | 90.0 | TMA | 10.0 | KF-6001 | 0.3 | 15.6 | 60 | 135 |
| P8 | BPA-PO | 50.0 | BPA-EO | 50.0 | TPA | 90.0 | TMA | 10.0 | — | 0.0 | — | 44 | 113 |

Using KF-6001 yields a structure in which all of R^{x} groups are methyl groups and n is 38 in formula (B).
BPA-PO: Bisphenol A propylene oxide adduct (average added moles 2.2)
BPA-EO: Bisphenol A ethylene oxide adduct (average added moles 2.2)
TPA: Terephthalic acid
TMA: Trimellitic anhydride

Manufacturing Example of Polymer A1

| | |
|---|---|
| Solvent: Toluene | 100.0 parts |
| Monomer composition | 100.0 parts |
| (The monomer composition is a | |
| mixture of the following behenyl | |
| acrylate, methacrylonitrile and | |
| styrene in the following proportions.) | |
| (Behenyl acrylate (first | 67.0 parts |
| polymerizable monomer) | (28.9 mol %)) |
| (Methacrylonitrile (second | 22.0 parts |
| polymerizable monomer) | (53.8 mol %)) |
| (Styrene (third polymerizable | 11.0 parts |
| monomer) | (17.3 mol %)) |
| Polymerization initiator: | 0.5 parts |
| t-butyl peroxypivalate | |
| (Perbutyl PV, NOF Corp.) | |

These materials were loaded in a nitrogen atmosphere into a reactor equipped with a reflux condenser, a stirrer, a thermometer and a nitrogen introduction pipe. The reactor contents were stirred at 200 rpm while being heated to 70° C., and a polymerization reaction was performed for 12 hours to obtain a solution of a polymer derived from the monomer composition dissolved in toluene. Next, this solution was cooled to 25° C., and added with stirring to 1000.0 parts of methanol to precipitate a methanol-insoluble component. The resulting methanol-insoluble component was filtered out, further washed with methanol, and vacuum dried for 24 hours at 40° C. to obtain a polymer Al. The polymer Al had a weight-average molecular weight of 68400, a melt peak temperature (melting point) of 62° C. and an acid value of 0.0 mg KOH/g. NMR analysis of this polymer Al showed that it contained 28.9 mol % monomer units derived from behenyl acrylate, 53.8 mol % monomer units derived from methacrylonitrile and 17.3 mol % monomer units derived from styrene. The SP values of the monomer units were calculated.

Manufacturing Examples of Polymers A2 to A17

Polymers A2 to A17 were obtained by the same reaction as in the manufacturing example of the polymer Al except that the monomers and mass parts thereof were changed as shown in Table 2. The physical properties are shown in Table 2.

TABLE 2
List of polymer formulations

| Polymer | | | mass | | Carbon | | | mass | | | SP | mass | | Acid | Melting | Molecular |
|---|---|---|---|---|---|---|---|---|---|---|---|---|---|---|---|---|
| A No. | 1st | SP1 | % | mol % | number | 2nd | SP2 | % | mol % | 3rd | value | % | mol % | value | point | weight |
| A1 | BEA | 18.3 | 67 | 28.9 | 22 | MN | 26.0 | 22 | 53.8 | St | 20.1 | 11 | 17.3 | 0 | 62 | 68400 |
| A2 | BEA | 18.3 | 71 | 28.9 | 22 | AN | 29.4 | 23 | 53.8 | St | 20.1 | 6 | 17.3 | 0 | 62 | 67100 |
| A3 | SA | 18.4 | 64 | 28.9 | 18 | MN | 26.0 | 24 | 53.8 | St | 20.1 | 12 | 17.3 | 0 | 54 | 66400 |
| A4 | MYA | 18.1 | 70 | 28.9 | 30 | MN | 26.0 | 20 | 53.8 | St | 20.1 | 10 | 17.3 | 0 | 76 | 62900 |
| A5 | OA | 18.1 | 69 | 28.9 | 28 | MN | 26.0 | 21 | 53.8 | St | 20.1 | 10 | 17.3 | 0 | 78 | 64500 |
| A6 | OA | 18.1 | 58 | 28.9 | 28 | HPMA | 24.1 | 32 | 53.8 | St | 20.1 | 10 | 17.3 | 0 | 59 | 67500 |
| A7 | OA | 18.1 | 68 | 28.9 | 28 | AM | 39.3 | 21 | 53.8 | St | 20.1 | 11 | 17.3 | 0 | 59 | 63900 |
| A8 | OA | 18.1 | 67 | 28.9 | 28 | VA | 21.6 | 23 | 53.8 | St | 20.1 | 10 | 17.3 | 0 | 56 | 64600 |
| A9 | OA | 18.1 | 67 | 28.9 | 28 | MA | 21.6 | 23 | 53.8 | St | 20.1 | 10 | 17.3 | 0 | 54 | 66400 |
| A10 | OA | 18.1 | 63 | 28.9 | 28 | MA | 21.6 | 10 | 21.0 | St | 20.1 | 27 | 50.1 | 0 | 55 | 62800 |
| A11 | OA | 18.1 | 27 | 7.0 | 28 | MA | 21.6 | 73 | 93.0 | — | — | — | — | 0 | 62 | 65800 |
| A12 | OA | 18.1 | 87 | 58.8 | 28 | MA | 21.6 | 6 | 21.0 | St | 20.1 | 7 | 20.2 | 0 | 55 | 63900 |
| A13 | OA | 18.1 | 86 | 58.8 | 28 | MA | 21.6 | 4 | 12.6 | MM | 20.3 | 10 | 28.6 | 0 | 56 | 63500 |
| A14 | OA | 18.1 | 15 | 4.2 | 28 | MA | 21.6 | 10 | 12.6 | St | 20.1 | 75 | 83.2 | 0 | 55 | 65600 |
| A15 | OA | 18.1 | 87 | 61.3 | 28 | MA | 21.6 | 4 | 12.6 | St | 20.1 | 9 | 26.1 | 0 | 62 | 65600 |
| A16 | OA | 18.1 | 18 | 4.2 | 28 | MA | 21.6 | 82 | 95.8 | — | — | — | — | 0 | 55 | 64400 |
| A17 | HA | 18.5 | 11 | 4.2 | 16 | MA | 21.6 | 89 | 95.8 | — | — | — | — | 0 | 45 | 66600 |

In the table, “1st” indicates the first monomer unit (polymerizable monomer), “2nd” indicates the second monomer unit (polymerizable monomer) and “3rd” indicates the third monomer unit (polymerizable monomer). The acid value is given in units of mg KOH/g and the melting point in units of ° C., and the molecular weight is the weight-average molecular weight.

The abbreviations in Table 2 are defined as follows.
Behenyl acrylate
SA: Stearyl acrylate
MYA: Myrisyl acrylate
OA: Octacosyl acrylate
HA: Hexadecyl acrylate
MN: Methacrylonitrile
AN: Acrylonitrile
HPMA: 2-hydroxypropyl methacrylate
AM: Acrylamide
VA: Vinyl acetate
MA: Methyl acrylate
St: Styrene
MM: Methyl methacrylate

Manufacturing Example of Toner 1

| | |
|---|---|
| Binder resin P1 | 100.0 parts |
| Polymer A1 | 5.0 parts |
| Fischer-Tropsch wax (peak temperature of | 6.0 parts |
| maximum endothermic peak: 90° C.): | |
| C.I. pigment blue 15:3 | 9.0 parts |

The raw materials shown in this formulation were mixed at a rotation speed of 20 s⁻¹ for a rotation time of 5 min with a Henschel mixer (FM75J, Mitsui Miike), and then kneaded in a twin-screw kneader (PCM-30, Ikegai) set to a temperature of 130° C. and a barrel rotation of 200 rpm. The kneaded product was cooled and crushed with a hammer mill to not more than 1 mm to obtain a crushed product. The crushed product was then pulverized with a mechanical pulverizer (T-250, Turbo Industries). This was then classified with a rotational classifier (200TSP, Hosokawa Micron) to obtain a toner particle 1. The resulting toner particle 1 had a weight-average particle diameter (D4) of 6.5 2.0 parts of hydrophobic silica (BET: 200 m²/g) were mixed with 100.0 parts of the resulting toner particle 1 in a Henschel mixer (FM75J, Mitsui Miike) at a rotation speed of 30 s⁻¹ for a rotation time of 5 min, and passed through an ultrasonic vibration sieve with a mesh opening of 54 μm to obtain a toner 1.

Manufacturing Examples of Toners 2 to 31

Toners 2 to 31 were manufactured as in the manufacturing example of the toner 1 except that the types of and amounts of the binder resin and polymer A were changed as shown in Table 3. The resulting toner particles 2 to 31 each had a weight-average particle diameter (D4) of 6.5 μm.

TABLE 3

| | Binder resin | | Polymer A | |
|---|---|---|---|---|
| | | Parts | | Parts |
| Toner 1 | P1 | 100.0 | A1 | 5.0 |
| Toner 2 | P1 | 100.0 | A2 | 5.0 |
| Toner 3 | P2 | 100.0 | A1 | 5.0 |
| Toner 4 | P3 | 100.0 | A1 | 5.0 |
| Toner 5 | P4 | 100.0 | A1 | 5.0 |
| Toner 6 | P5 | 100.0 | A1 | 5.0 |
| Toner 7 | P6 | 100.0 | A1 | 5.0 |
| Toner 8 | P7 | 100.0 | A1 | 5.0 |
| Toner 9 | P7 | 100.0 | A3 | 5.0 |
| Toner 10 | P7 | 100.0 | A4 | 5.0 |
| Toner 11 | P7 | 100.0 | A5 | 5.0 |
| Toner 12 | P7 | 100.0 | A5 | 3.0 |
| Toner 13 | P7 | 100.0 | A5 | 8.0 |
| Toner 14 | P7 | 100.0 | A5 | 1.0 |
| Toner 15 | P7 | 100.0 | A5 | 10.0 |
| Toner 16 | P7 | 100.0 | A5 | 12.0 |
| Toner 17 | P7 | 100.0 | A5 | 0.5 |
| Toner 18 | P7 | 100.0 | A6 | 0.5 |
| Toner 19 | P7 | 100.0 | A7 | 0.5 |
| Toner 20 | P7 | 100.0 | A8 | 0.5 |
| Toner 21 | P7 | 100.0 | A9 | 0.5 |
| Toner 22 | P7 | 100.0 | A10 | 0.5 |
| Toner 23 | P7 | 100.0 | A11 | 0.5 |
| Toner 24 | P7 | 100.0 | A12 | 0.5 |
| Toner 25 | P7 | 100.0 | A13 | 0.5 |
| Toner 26 | P7 | 100.0 | A14 | 0.5 |
| Toner 27 | P7 | 100.0 | A15 | 0.5 |
| Toner 28 | P7 | 100.0 | A16 | 0.5 |
| Toner 29 | P7 | 100.0 | A17 | 0.5 |
| Toner 30 | P7 | 100.0 | — | — |
| Toner 31 | P8 | 100.0 | — | — |

Manufacturing Example of Magnetic Core Particle

Step 1: Weighing and Mixing Step

| | |
|---|---|
| Fe₂O₃ | 62.7 parts |
| MnCO₃ | 29.5 parts |
| Mg(OH)₂ | 6.8 parts |
| SrCO₃ | 1.0 parts |

The materials listed above were weighed out as ferrite starting materials in the compositional ratio indicated above. This was followed by mixing and pulverization for five hours using a dry vibrating mill and stainless steel beads having a diameter of 1/8 inch.

Step 2: Pre-firing Step

The resulting pulverized material was converted into approximately 1 mm-square pellets using a roller compactor. Coarse powder was removed from these pellets using a vibrating screen having an aperture of 3 mm; the fines were then removed using a vibrating screen having an aperture of 0.5 mm; and firing was thereafter carried out in a burner-type firing furnace under a nitrogen atmosphere (0.01 volume% oxygen concentration) for four hours at a temperature of 1000° C. to produce a prefired ferrite. The composition of the obtained prefired ferrite was as follows.

(MnO)ₐ(MgO)_{b}(SrO)_{c}(Fe₂O₃)_{d}

In the formula, a=0.257, b=0.117, c=0.007, d=0.393.

Step 3: Pulverization Step

The obtained prefired ferrite was pulverized with a crusher to about 0.3 mm, followed by the addition of 30 parts of water per 100 parts of the prefired ferrite and pulverization for one hour with a wet ball mill using zirconia beads with a diameter of 1/8 inch. The obtained slurry was pulverized for four hours with a wet ball mill using alumina beads having a diameter of 1/16 inch to obtain a ferrite slurry (fine pulverizate of the prefired ferrite).

Step 4: Granulation Step

1.0 parts of an ammonium polycarboxylate as a dispersing agent and 2.0 parts of polyvinyl alcohol as a binder were added to the ferrite slurry per 100 parts of the prefired ferrite, followed by granulation into spherical particles using a spray dryer (manufacturer: Ohkawara Kakohki Co., Ltd.). The particle size of the obtained particles was adjusted followed by heating for two hours at 650° C. using a rotary kiln to remove the organic component, e.g., the dispersing agent and binder.

Step 5: Firing Step

In order to control the firing atmosphere, the temperature was raised over two hours using an electric furnace from room temperature to a temperature of 1300° C. under a nitrogen atmosphere (1.00 volume% oxygen concentration), and firing was then performed for four hours at a temperature of 1150° C. This was followed by reducing the temperature to a temperature of 60° C. over four hours, returning to the atmosphere from the nitrogen atmosphere, and removal at a temperature of 40° C. or below.

Step 6: Selection Step

The aggregated particles were broken up; the low magnetic force product was then removed using a magnetic force classifier; and the coarse particles were removed by sieving on a sieve with an aperture of 250 μm to obtain magnetic core particles 1 having a median diameter on a volume basis of 37.0

Preparation of Coating Resin
Cyclohexyl methacrylate 26.8 mass %
Methyl methacrylate 0.2 mass %
Methyl methacrylate macromonomer (macromonomer with weight-average molecular weight of 5000 having methacryloyl group at one end):8.4 mass %
Toluene 31.3 mass %
Methyl ethyl ketone 31.3 mass %
Azobisisobutyronitrile 2.0 mass %

Of these materials, the cyclohexyl methacrylate, methyl methacrylate, methyl methacrylate macromonomer, toluene and methyl ethyl ketone were placed in a four-necked separable flask having an attached reflux cooler, thermometer, nitrogen introduction pipe and stirrer. Nitrogen was introduced into the separable flask to substitute nitrogen gas inside the system. The temperature was then raised to 80° C., the azobisisobutyronitrile was added, and the mixture was refluxed and polymerized for 5 hours. Hexane was injected into the reaction product to precipitate a copolymer, and the precipitate was filtered out and vacuum dried to obtain a coating resin 1. 30 parts of the resulting coating resin 1 were dissolved in 40 parts of toluene and 30 parts of methyl ethyl ketone to obtain a polymer solution 1 (solids 30 mass %).

Preparation of Coating Resin Solution
Polymer solution 1 (resin solids concentration 30 mass %) 33.3 mass %
Toluene 66.4 mass %
Carbon black (primary particle diameter 25 nm, nitrogen adsorption specific surface area 94 m²/g, DPB oil absorption 75 ml/100 g) 0.3 mass %

These materials were dispersed for 1 hour with a paint shaker using zirconia beads 0.5 mm in diameter. The resulting dispersion was filtered with a 5.0 μtm membrane filter to obtain a coating resin solution 1.

Manufacturing Example of Magnetic Carrier Resin Coating Step

In a vacuum degassing kneader maintained at room temperature, the coating resin solution 1 was added to 100 parts of the magnetic core particle 1 in the amount of 2.5 parts of the resin component. After addition, this was stirred for 15 minutes at a rotation speed of 30 rpm, and once at least a certain amount (80 mass %) of the solvent had evaporated, mixing was performed reduced pressure as the temperature was raised to 80° C., the toluene was distilled off over the course of 2 hours and the mixture was cooled. A magnetic dressing was used to remove low-magnetic products from the resulting magnetic carrier, which was then passed through a 70 μm sieve and classified with an air classifier to obtain a magnetic carrier 1 with a median diameter of 38.2 μm based on volume distribution.

Manufacturing Examples of Two-Component Developers 1 to 31

Each of the toners 1 to 31 was mixed with the magnetic carrier 1 (number-average particle diameter 35 μm) at 0.5 s⁻¹ for 5 minutes with a V mixer (V-10, Tokuju Corp.) to a toner concentration of 9 mass % to obtain two-component developers 1 to 31.

Toner Evaluation

The evaluation was performed using a modified imagePRESS C800 Canon full-color copier as the image-forming apparatus. This image-forming apparatus has a photosensitive member as an image bearing member for forming electrostatic latent images, and the electrostatic latent images on the photosensitive member are developed into toner images using the two-component developer in a developing step. The developed toner image is then transferred to an intermediate transfer member, after which the toner image on the intermediate transfer member is transferred to the paper in a transfer step, and the toner image on the paper is fixed by heat in a fixing step. This image-forming apparatus was modified so as to allow alterations to the fixing temperature and process speed.

Charge Stability Evaluation

The charge quantity of the toner on the electrostatic latent image bearing member was measured with a Faraday Cage, and charge stability was evaluated. A Faraday Cage consists of a coaxial double cylinder in which the inner cylinder is insulated from the outer cylinder. When a charged body with a charge quantity Q is placed in the inner cylinder, electrostatic induction makes it as if there is a metal cylinder with a charge quantity Q. This induced charge quantity is measured with an electrometer (Keithley 6517A), and the charge quantity Q (mC) is divided by the toner mass M (kg) inside the cylinder (Q/M) and given as the charge quantity per unit mass.

Paper: CS-680 (68.0 g/m²) (Canon Marketing Japan)

Evaluation image: 2 cm×5 cm image in center of above A4 paper

Toner laid-on level on paper: 0.35 mg/cm²

(adjusted by adjusting the DC voltage VDC of the developer carrying member, the charge voltage VD of the electrostatic image bearing member and the laser power)

Test environment: High-temperature high-humidity environment (30° C./80% RH, hereunder H/H)

Process speed: 377 mm/s

The two-component developer 1 was placed in the cyan station developing device of the above image-forming apparatus and evaluated. To stabilize the evaluation unit, 10 sheets were output on A4 paper using a band chart with an image ratio of 0.1%. The above evaluation image was then formed on the electrostatic latent image bearing member, the rotation of the electrostatic latent image bearing member was stopped before the image could be transferred to the intermediate transfer member, and the toner on the electrostatic latent image bearing member was collected by suction using a metal cylindrical tube and a cylindrical filter. The initial Q/M (mC/kg) on the electrostatic latent image bearing was measured by measuring the charge quantity Q stored in the condenser and the mass M of the collected toner through the metal cylindrical tube, and using these to calculate the charge quantity Q/M (mC/kg) per unit mass.

The evaluation unit was then left with the developer inside for two weeks in an H/H environment and restarted, and immediately after the evaluation unit was restarted the Q/M (mC/kg) on the electrostatic latent image bearing member after storage was measured by the same operations used before storage. The Q/M retention rate on the electrostatic latent image bearing member after testing was then calculated by the formula below. The resulting Q/M retention rate on the electrostatic latent image bearing member after endurance testing was then evaluated by the following evaluation standard.

Q/M retention rate on electrostatic latent image bearing member after endurance testing =

{Q/M on electrostatic latent image bearing member after endurance testing/initial Q/M on electrostatic latent image bearing member}×100

### Evaluation Standard

A: Q/M retention rate at least 95%

B: Q/M retention rate at least 90% and less than 95%

C: Q/M retention rate at least 85% and less than 90%

D: Q/M retention rate at least 80% and less than 85%

E: Q/M retention rate at least 75% and less than 80%

F: Q/M retention rate less than 75%

Image Scratch Resistance Evaluation

Paper: SPLENDLUX 135 (135.0 g/m², Fedrigoni)

Evaluation image: 2 cmx15 cm image in center of above A4 paper

Toner laid-on level on paper: 0.90 mg/cm²

(adjusted by adjusting the DC voltage V_{DC} of the developer carrying member, the charge voltage VD of the electrostatic image bearing member and the laser power)

Test environment: Normal-temperature normal-humidity environment (23° C/50% RH, hereunder N/N)

Process speed: 248 mm/s

The two-component developer 1 was placed in the cyan station developing device of the above image-forming apparatus and evaluated. The evaluation image was printed at a fixing temperature of 170° C. Image scratch resistance was evaluated by scratching the recording paper with the evaluation image formed thereon for a length of 30 mm at a speed of 60 mm/min with a Φ0.75 mm needle under 200 g of load using a HEIDON TYPE 14FW surface tester made by Shinto Scientific Co., Ltd. The area ratio of toner detachment was binarized by image processing.

### Evaluation Standard

A: No image scratching

B: Image scratching occurred, area ratio of toner detachment less than 1.0%

C: Image scratching occurred, area ratio of toner detachment at least 1.0% and less than 2.0%

D: Image scratching occurred, area ratio of toner detachment at least 2.0% and less than 4.0%

E: Image scratching occurred, area ratio of toner detachment at least 4.0% and less than 6.0%

F: Image scratching occurred, area ratio of toner detachment at least 6.0%

The two-component developers 2 to 31 were evaluated in the same way as the two-component developer 1. The results are shown in Table 4.

TABLE 4

| | Two-component | | | | | Image scratch | |
|---|---|---|---|---|---|---|---|
| | developer | | | Charge stability | | resistance | |
| | | Toner | Magnetic | evaluation | | evaluation | |
| | No. | No. | carrier No. | Rank | % | Rank | % |
| Example 1 | 1 | 1 | 1 | A | 98 | A | 0 |
| Example 2 | 2 | 2 | 1 | A | 98 | A | 0 |
| Example 3 | 3 | 3 | 1 | A | 98 | A | 0 |
| Example 4 | 4 | 4 | 1 | A | 98 | A | 0 |
| Example 5 | 5 | 5 | 1 | A | 95 | B | 0.5 |
| Example 6 | 6 | 6 | 1 | A | 95 | B | 0.5 |
| Example 7 | 7 | 7 | 1 | B | 91 | B | 0.8 |
| Example 8 | 8 | 8 | 1 | B | 91 | B | 0.8 |
| Example 9 | 9 | 9 | 1 | C | 87 | C | 1.5 |
| Example 10 | 10 | 10 | 1 | C | 87 | C | 1.5 |
| Example 11 | 11 | 11 | 1 | C | 87 | C | 1.5 |
| Example 12 | 12 | 12 | 1 | C | 87 | C | 1.5 |
| Example 13 | 13 | 13 | 1 | C | 87 | C | 1.5 |
| Example 14 | 14 | 14 | 1 | C | 85 | D | 2.8 |
| Example 15 | 15 | 15 | 1 | C | 85 | D | 2.8 |
| Example 16 | 16 | 16 | 1 | D | 82 | D | 3.5 |
| Example 17 | 17 | 17 | 1 | D | 82 | D | 3.5 |
| Example 18 | 18 | 18 | 1 | D | 80 | E | 5.5 |
| Example 19 | 19 | 19 | 1 | D | 80 | E | 5.5 |
| Example 20 | 20 | 20 | 1 | E | 78 | E | 4.5 |
| Example 21 | 21 | 21 | 1 | E | 78 | E | 4.5 |
| Example 22 | 22 | 22 | 1 | E | 76 | E | 5.5 |
| Example 23 | 23 | 23 | 1 | E | 76 | E | 5.7 |
| Example 24 | 24 | 24 | 1 | E | 76 | E | 5.7 |
| Comparative Example 1 | 25 | 25 | 1 | F | 70 | F | 6.5 |
| Comparative Example 2 | 26 | 26 | 1 | F | 68 | F | 6.5 |
| Comparative Example 3 | 27 | 27 | 1 | F | 68 | F | 6.5 |
| Comparative Example 4 | 28 | 28 | 1 | F | 68 | F | 6.5 |
| Comparative Example 5 | 29 | 29 | 1 | F | 66 | F | 7.0 |
| Comparative Example 6 | 30 | 30 | 1 | E | 75 | F | 6.5 |
| Comparative Example 7 | 31 | 31 | 1 | F | 65 | E | 5.8 |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions. This application claims the benefit of Japanese Patent Application No. 2020-063233, filed Mar. 31, 2020, and Japanese Patent Application No. 2021-031660, filed Mar. 1, 2021, which are hereby incorporated by reference herein in their entirety.

What is claimed is:

1. A toner comprising a toner particle containing a binder resin and a polymer A, wherein
the binder resin contains a polyester resin having a structure represented by formula (B) below: 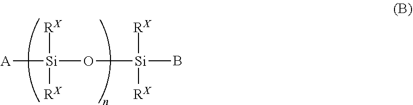
in formula (B) each R^{x} independently represents a hydrogen atom, methyl group or phenyl group,
A represents a polyester segment,
B represents a polyester segment or any functional group selected from the group consisting of —R²⁰OH, —R²⁰COOH, 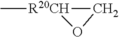
and —R²⁰NH₂, where
R²⁰ represents a single bond or C₁₋₄ alkylene group, and
an average number of repetitions n is 10 to 80,
the polymer A comprises a first monomer unit having a structure represented by formula (I) below and a second monomer unit that is different from the first monomer unit: 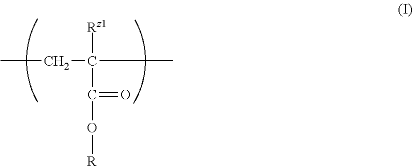
in formula (I), R^{Z1} represents a hydrogen atom or methyl group, and R represents a C₁₈₋₃₆ alkyl group,
a content ratio of the first monomer unit in the polymer A is 5.0 mol % to 60.0 mol % based on a total molar amount of all monomer units in the polymer A,
a content ratio of the second monomer unit in the polymer A is 20.0 mol % to 95.0 mol % based on a total molar amount of all monomer units in the polymer A, and
when SP1 (J/cm³)^{0.5} is an SP value of the first monomer unit, and SP2 (J/cm³)^{0.5} is an SP value of the second monomer unit, and SP3 (J/cm³)^{0.5} is an SP value of a silicone segment represented by —(Si(R^{x})₂O)ₙ—Si(R^{x})₂— in the structure represented by formula (B), formulae (1) to (3) below are satisfied:
SP1≤18.4 (1)
21.0≤SP2 (2)
SP1−SP3<SP2−SP1 (3)

2. The toner according to claim 1, wherein the second monomer unit is at least one selected from the group consisting of formulae (II) and (III) below: 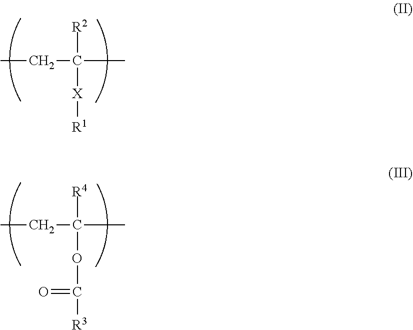
in formula (II), X represents a single bond or C₁₋₆ alkylene group;
R¹ is —C≡N,
—C(═O)NHR¹⁰ (where R¹⁰ is a hydrogen atom or C₁₋₄ alkyl group), a hydroxy group,
—COOR¹¹ (where R¹¹ is a hydrogen atom, C₁₋₆ alkyl group or C₁₋₆ hydroxyalkyl group),
—NHCOOR¹² (where R¹² is a C₁₋₄ alkyl group),
—NH—C(═O)—N(R¹³)₂ (where each of two R¹³ groups is independently a hydrogen atom
or C₁₋₆ alkyl group),
—COO(CH₂)₂NHCOOR¹⁴ (where R¹⁴ represents a C₁₋₄ alkyl group) or
—COO(CH₂)₂—NH—C(═O)—N(R¹⁵)2 (where each of two R¹⁵ groups is independently a hydrogen atom or C₁₋₆ alkyl group); and
R² represents a hydrogen atom or methyl group, and
in formula (III), R³ represents a C₁₋₄ alkyl group and R⁴ represents a hydrogen atom or methyl group.

3. The toner according to claim 1, wherein a content of the polymer A is from 1.0 mass parts to 10.0 mass parts per 100 mass parts of the binder resin.

4. The toner according to claim 1, wherein R^{Z1} is a hydrogen atom and R is a C₂₂ alkyl group in the formula (I).

5. The toner according to claim 1, wherein a content of the silicone segment in the polyester resin having the structure represented by formula (B) is from 0.5 mass % to 5.0 mass %.

6. The toner according to claim 1, wherein all of R^{x} groups in formula (B) are methyl groups.

7. The toner according to claim 1, wherein the SP2 satisfies formula (2)′ below:
25.0≤SP2≤30.0 (2)′.

8. The toner according to claim 1, wherein in the binder resin, a content of the polyester resin having the structure represented by formula (B) is at least 50 mass %.
